(19) United States
(12) Patent Application Publication
(10) Pub. No.: US 2026/0341050 A1
(43) Pub. Date: Oct. 29, 2026

(54) TRAINING AI MODEL FOR A MICROSCOPE-BASED PATTERN PHOTOILLUMINATION SYSTEM

(71) Applicants: Jung-Chi LIAO, Taipei City (TW); SYNCELL (TAIWAN) INC., Taipei City (TW)

(72) Inventors: Jung-Chi LIAO, Taipei City (TW); Chun Kai HUANG, Taipei City (TW)

(21) Appl. No.: 18/997,408

(22) PCT Filed: Jul. 18, 2023
(86) PCT No.: PCT/US2023/070370

§ 371 Date: Jan. 21, 2025

Related U.S. Application Data
(60) Provisional application No. 63/368,704, filed on Jul. 18, 2022.

(51) Int. Cl. G06V 20/69; G02B 21/36; G06V 10/141; G06V 10/145; G06V 10/25

(52) U.S. Cl. CPC G06V 20/693; G02B 21/365; G06V 10/141; G06V 10/145; G06V 10/25; G06V 20/695; G06V 20/698

(57) ABSTRACT

A method for training an artificial intelligence model for a microscope-based pattern photo-illumination including selecting an AI-model architecture having a predetermined number of convolutional layers between an input and an output layer. Then introducing to the AI-model one or more images captured by a microscope-based system having an image processing system, the one or more images labeled with known regions of interest for processing through the predetermined number of convolutional layers. Assessing the output values against the known regions of interest and accepting the output values as validated for identification of regions of interest. The output values may be further implemented in the generation of a mask pattern.

### CLAIM OF PRIORITY

This application claims priority to U.S. Provisional Patent Application No.

63/368,704, filed on Jul. 18, 2022, titled “TRAINING AI MODEL FOR A MICROSCOPE-BASED PATTERN PHOTOILLUMINATION SYSTEM,” which is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

Artificial intelligence models and systems have increased the accuracy, efficiency, and capabilities of image processing systems. Artificial neural networks are employed in a wide range of applications from transportation to medicine as they provide an opportunity to metabolize complex data that results in relevant and practical output information.

In particular, the biomedical field has benefitted greatly from advancements in both AI models. Disease diagnosis, treatment strategies, drug development, research and more are increasing reliance and incorporation of AI to accelerate improved understanding of anatomy and physiology. However, current systems relating to digital image processing of biological samples are deficient in their identification of important cellular structure and function. These deficiencies in the current state of the art promotes continued reliance on empirical approaches to understanding complex structures and associated functions. For example, rather than visual confirmation of a specific structure or event, genomic sequencing may be used and often require an amalgam of research to justifies quantified assay results. This is laborious and may be associated with decreased accuracy of the results.

Advances in microscopy may allow for more detailed visualization of cellular biology but require the user to have substantial amounts of education and training; and still result in decreased accuracy and efficiency. The subjectivity with user-based microscopy, even with relevant dyes and probes can result in misinterpretation or missed novel opportunities. Precise identification of targetable abnormalities can benefit diagnostic and treatment.

For these reasons, it would be desirable to provide improved methods, systems, and tools for training artificial intelligence models and associated artificial neural networks. It would be particularly desirable to provide simplified systems and methods relating to computer-implemented image processing artificial intelligence models that may be used in generating mask patterns for photochemical illumination. At least some of these objectives will be met by the various embodiments that follow.

### SUMMARY OF THE DISCLOSURE

Described herein are systems and methods for training an AI-model for use in generating a mask pattern for photo-illumination of a sample associated with a microscope-based system.

A method for training an artificial intelligence model for microscope-based pattern photo-illumination is provided, the method comprising the steps of: obtaining an image of a sample captured by a microscope-based system, wherein the image has a target pattern corresponding to regions of interest; inputting the image to an input layer of an artificial intelligence model architecture having a number of layers between the input layer and an output layer; outputting a proposed pattern corresponding to the regions of interest with the output layer of the artificial intelligence model architecture; comparing the proposed pattern against the target pattern to calculate a loss between the proposed pattern and the target pattern; updating weights in the layers of the artificial intelligence model architecture based on the calculated loss; and repeating the inputting, outputting, comparing, and updating steps until the calculated loss is below a loss threshold.

In one aspect, the method includes the step of pre-processing the image to standardize image pixel values across the image.

In some aspects, more than one region of interest is annotated on the images prior to being introduced to the artificial intelligence model architecture.

In some aspects, the regions of interest are labeled with one or more probes configured to bind to the regions of interest.

In some aspects, more than one region of interest is labeled with a probe.

In one aspect, each region of the more than one region of interest is labeled with a different probe.

In some implementations, the microscope-based system is configured to illuminate the regions of interest.

In some aspects, the selected artificial intelligence model architecture comprises a network of artificial intelligence models in communication with one another.

In some aspects, the method includes the step of a first artificial intelligence model segmenting one or more features within the image captured by the microscope-based system.

In some implementations, the method includes training additional artificial intelligence models within the network.

In some aspects, each of the one or more images obtained from the microscope-based system are captured with a different field of view.

A method for generating a mask for pattern-illumination of a sample using a microscope-based system is provided, the method comprising: capturing an image of a target field of view (FOV) of a sample with an image capture system of a microscope-based system; inputting the image into a trained artificial intelligence model; outputting a mask pattern with the trained artificial intelligence model corresponding to one or more regions of interest in the sample; and controlling an illuminating assembly of the microscope-based system to illuminate the one or more regions of interest of the sample with the mask pattern.

In some aspects, the method includes standardizing image pixel values of the image.

In some aspects, inputting the image further comprises inputting the standardized image pixel values into the artificial intelligence model.

In one aspect, the mask pattern comprises more than one region of interest.

In another aspect, the trained artificial intelligence model is configured to segment the one or more regions of interest from the input image.

In one aspect, the sample is a biological sample.

In another aspect, the microscope-based system is configured to capture images of more than one target FOV of the sample.

In some aspects, the method includes combining the sample with one or more probes, the one or more probes configured to engage one or more elements within the sample, and wherein the one or more probes are reactive to light from the illumination assembly.

A method for generating a mask pattern using an artificial intelligence model in a microscope-based system is provided, the method comprising: introducing one or more photoactivatable probes to a sample of a microscope-based system, the one or more photoactivatable probes being configured to bind to one or more regions of interest of the sample; capturing an image of the sample with an illumination system of the microscope-based system; inputting the image to an input layer of a trained artificial intelligence model; outputting a mask pattern with the trained artificial model corresponding to one or more regions of interest in the sample; and controlling an illuminating assembly of the microscope-based system to illuminate the one or more regions of interest of the sample with the mask pattern, and the illumination assembly being configured to activate the one or more photoactivatable probes.

In one aspect, the mask pattern is based on a distribution of the one or more photoactivatable probes within the sample.

In another aspect, the mask pattern comprises more than one region of interest.

In some aspects, the trained artificial intelligence model has been trained using validated examples of regions of interest from training images.

In another aspect, the trained artificial intelligence model has been trained using microscope-based system input, and wherein the trained artificial intelligence model is configured to segment one or more regions of interest from pixel value data of training images.

In some aspects, the sample is a biological sample.

In some aspects, the microscope-based system is configured to capture more than one image of the sample.

In another aspect, each of the one or more images are captured by the microscope-based system with a different field of view (FOV).

In some aspects, one or more photoactive probes are reactive to light from the illumination assembly.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 illustrates an example of a process associated with training an artificial intelligence model for microscope-based pattern illumination according to methods described herein.

FIG. 2 is a flowchart describing a method of training an AI model.

FIGS. 3-4 are flowcharts describing methods of performing pattern illumination of a sample with a microscope-based system.

FIG. 5 is an example of a microscope-based system for performing pattern illumination of a sample.

### DETAILED DESCRIPTION

Computer-implemented image processing generally involves one or more image processing algorithm used in a neural network for the evaluation and transformation of an input (e.g., an image obtained from a microscope-based system). For example, an artificial intelligence (AI) model may employ one or more image processing algorithms to generate a mask used in photochemical illumination of a target object or region of interest within the image. Image processing of biological samples can provide efficient and specific identification of structures and related functions to an intracellular level. However, training the AI model is a uniquely associated with the AI functionality and capabilities.

An AI model may comprise one or more artificial neural networks (ANN) (e.g., neural network) operating through activating algorithms that are configured to modify or transform data across one or more hidden layers. For example, a convolutional neural network (CNN) may be configured within a computer-based system having an input layer and an output layer with one or more hidden layers therebetween. The hidden layers of the CNN may be associated with an activating algorithm relating to desirable manipulation or transformation of the data passing therethrough. For example, input data (e.g., an image obtained from a microscope-based system). The input image may then be subjected to the input layer that may have different segments of the layer. Each layer segment may be associated with a different weight or coefficient applied to a numerical representation of a segment of the input data. The weight and numerical representation of the segment of data may then be subjected to an activating algorithm at a hidden layer adjacent to the input layer. The activating algorithm of the adjacent hidden layer may incorporate the weight and the numerical representation of the data segment for continued processing through the remaining layers of the CNN. Again, a weight may be associated with the convolution from the first hidden layer and may be incorporated into one or more subsequent activating algorithms at various hidden layers throughout the CNN. A final layer of the CNN may be an output layer where a final adjustment of the data may be performed and a resulting in an output value related to the input data, or a segment thereof.

In some examples, AI models rely on one or more algorithms to process data from the input to an output value. The algorithms may consider data relating to the input image as well as certain coefficients or weights and biases that are incorporated into the AI model. Reducing the number of algorithms may reduce the amount of time needed for the AI model to process the data. For example, each hidden layer may comprise multiple algorithms, each requiring time to compute (e.g., convolute). Therefore, preprocessing of the image to standardize the image pixel values may reduce the amount of processing time within the AI model by reducing the number of algorithms required to perform the processing. Pre-processing of the image may also reduce the number of errors or need for additional validation within the AI model. In some examples, the data is processed by the AI model without validation. For example, a data set to be processed by the AI model (e.g., a data set associated with an image) may not be validated, or otherwise require validation prior to, or after processing by the AI model. In some examples, the data set to be processed by the AI may be a quantity of data that is sufficiently small and will not require validation based on the size of the dataset.

An example of an AI model may include a convolutional neural network relating to a U-net. A U-net may be a type of convolutional neural network used for image processing, according to any method described herein. A microscope-based system may have a computer-based system operating the AI model, according to any method described herein. The AI model may process one or more image inputs or data input into a first layer of the U-net convolutional neural network (e.g., the U-net). A U-net may process the image through a series of layers. The processing layers of the U-net may be considered in one or more phases or paths of the image processing. For example, one phase may be the encoding (convolution) processing of the image. The down-conversion path may include one or more pooling layers (e.g., max-pooling layer) pooling layers between each of the down-conversion hidden layers. In some examples, the pooling layers process data relating to image pixel values and a pooling layer may sample the greatest image pixel values of a previous layer. The layers may alternate between a pooling layer and a down-converted layer. Each down-converted layer may have different pixel values compared to previous down-converted layers. In some examples, a second phase of the U-net may be the decoding (deconvolution) phase starting between the input layer and the and up-conversion layers. In some examples, the up-conversion layers are separated by at least one up-sampling layer. Each up-conversion layer may include additional data added during an up-sampling layer that is configured to provide additional information relating to the data of the image input into the system.

In some examples, the pre-processing of an image to standardize the image pixel values may reduce the required number of pooling layers and convolutional layers of the imaging process. For example, an image input into the system that has not been pre-processed may require additional pooling layers and additional convolutional layers to compensate for the unstandardized image pixel values. Alternatively, where an image has been preprocessed, fewer layers of pooling layers and convolution layers may not be necessary to process the image.

In some examples, the pre-processing of an image to standardize the image pixel values may reduce or eliminate algorithms used in processing the image though the hidden layers of an AI model. For example, an image having standardized image pixel values may have pixel value distributions that are recognized by the trained AI model allowing the AI model to process the image by predicting a mask pattern relating to the image input as described herein. In some examples, the AI model may be sufficiently trained recognize aspects or attributes of the image data inputs that may allow the AI model to predict an appropriate mask to be use with the microscope-based system illumination system for photochemical illumination of unmasked segments or portions of the sample. Where the image has standardized image pixel values relating to intensities of pixels contained within the image, the arrangement and distribution of those pixels may allow the AI model to recognize the components and features of the image based on the distribution, intensities, and other attributes of the pixel values distributed throughout the image input. For example, a tissue sample having a plurality of cells distributed thereon may be input into the microscope-based system. The cells may be at different stages of mitotic activity having observed changes in morphology that may relate to unique patterns or distribution of pixel intensities comprising the cells undergoing mitosis. Accordingly, images may be captured of this sample and input into the trained AI model. The AI model may recognize the input and the input relating to the cellular attributes associated with mitosis. The AI model may then predict a mask relating to mitotic cells to rapidly identify those cells in the sample undergoing mitosis. The predicted mask may be sufficient to highlight or otherwise identify cells undergoing mitosis and exclude other objects of features of the image.

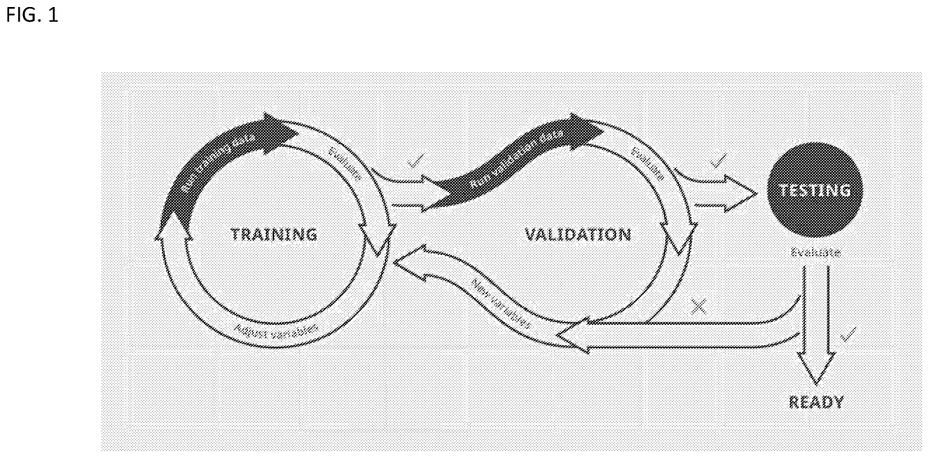

In some examples, the AI model is trained in one or more phases, as shown in FIG. 1. For example, a first phase may be a training phase wherein the AI model runs training data, evaluates outputs based on the training data, and adjusts variables (e.g., weights of the layers) based on the evaluation.

Still referring to FIG. 1, a second phase may be a validation phase that includes running validation data, evaluating outputs based on the validation data, and optionally adding one or more new variables within the AI model based on the evaluation; or testing the validation data within the AI model. When the validation data is evaluated, the AI model may be ready for use with sample data not part of the test data or validation data.

As illustrated in FIG. 1, two phases are shown. In the training phase, the method may operate in a selectively openable loop including running the training data, evaluating the training data after it is run through the AI model, and adjusting variables as needed, required, or desired by an operator and/or for a particular use. A second validation phase (e.g., an optional validation phase) illustrates where the training phase proceeds and validation data may be introduced for processing through the validation phase. In particular, the validation phase may include processing the validation data that may include the evaluated training data from the training phase. The validation data may then be evaluated and either continue through the validation phase for adjustment of one or more variables of the AI.

The evaluated validation data may alternatively be introduced to a testing phase within the AI model. The testing phase may continue with an additional validation of the testing phase data. After the testing data has been evaluated, the AI model may be identified as sufficiently trained and ready for use in processing data for photo illumination. In some examples, if evaluation of the testing data fails, the testing data may be reintroduced back into the validation phase. New variables or adjustment to AI associated variables may be included in the validation phase. If there are adjustments to the AI associated variables, the data may be reintroduced to the training phase for initial processing and evaluation. In some examples, the output values of the AI model processing may include the data being evaluated. For examples, the training phase may include output values from the data processed by the AI model. The output values may refer to the data being submitted or subjected to evaluation in any of the phases according to any method described herein.

A method for training an AI model in the generation of a mask pattern for photochemical illumination used with a microscope-based system may include training the AI model to apply a map to a sample introduced to the microscope-based system. The map may be coordinated with the sample (e.g., a general reference map of the sample within the microscope-based system). The reference map may be developed using image pixel values of an image obtained of the sample by the microscope-based system. The map may have data relating to the sample it is derived from and the map may be input into an AI model (e.g., a neural network). The neural network may convolute the data through one or more hidden layers between the input layer and the output layer of the neural network. According to the output, a region of interest or object may be identifiable by the AI model for mask generation. For example, a structure or feature of the sample having been incorporated into the map may result in a value of an output relating to the region of interest or object. When an acceptable output is achieved, the characteristics of the map relating to the acceptable output may be used by the AI model to generate a mask relating to the accepted map. A mask may then be generated relating to the map for use with the microscope-based system and associated illumination systems.

In some examples, a method of training an AI model may include comparing an output of the AI model to an expected output, and updating weights in the AI model based on this comparison (e.g., loss). For example, in some implementations, new data (e.g., an image of a sample obtained by a microscope-based system) may be input into the AI model. The AI model can perform forward propagation to encode the image through convolutional layers. The AI model can then produce an output, which can be compared to an expected output to calculate a loss which is a value that represents the difference between the output and the expected output. In one specific implementation, the input image can be a target field of view (FOV) of a sample, and the output can comprise a mask pattern corresponding to regions of interest of the target FOV of the sample. The mask pattern can be compared to an expected mask pattern to calculate the loss.

In some examples, the method of training an AI model in the generation of a mask pattern for photochemical illumination can further include backwards propagation from the output layer back to the input layer through the hidden layer algorithms of the AI model. The backward propagation can update weights in the AI model for use in additional training. In one specific example, the first output result may trigger reverse or backwards propagation of the data processed through the system such that a resulting backward propagation output may trigger or initiate the input of additional data from the sample (e.g., the map). The new or additional data from the sample may be a regional map or a map coordinating with a smaller region or more specific of a regional geometry that the initial map. Accordingly, the new or additional data from the regional map is introduced into the input layer of the AI model neural network and processed to the output layer through the one or more hidden layers.

In some examples, a cycle of forward and reverse propagation may continue until an output of a specific region of interest, feature or object of the sample is identifiable. For example, the regional map may continue to have a smaller surface area that previous maps of the same sample. In some examples of any method described herein, subsequent regional maps may be rejected as invalid segmented maps or regions of the initial map. For example, where the sample relates to tissue or a plurality of cells, the initial map may be of the entire sample include different cell types, structures, and features. When the initial map is processed through the AI model, an output is generated, the output triggers reverse propagation, and additional or new regional map is initiated then processed, the new map may be rejected as not part of the region of interest and on subsequent reverse propagation, a new regional map is established that does not include the previous map.

In some examples, training an AI model in generating a mask pattern for photo-illumination with a microscope-based system may include introducing a sample to a microscope-based system. The microscope-based system may have a computer-based system therein operating an AI model that may generate a first map relating to the sample. For example, the first map may relate to the entire sample of substantially all of the sample. The first map is then introduced into the AI model (e.g., a neural network) and processed from the input layer through one or more hidden layers operating an algorithm therein at various neurons. The algorithm may include a set algorithm incorporating values relating to the input data (e.g., the image or map of the sample) and one or more attributes such as weight or bias input associated with processing through the hidden layers. The data may be processed though the neural network to an output layer where one or more classes of output may indicate an associated value relating to the class of output. In some examples, the output may trigger or initiate re-establishing a map of the sample. Any method described herein may include each of the layers having biases and weights, both of which can be dynamically adjusted based on loss function or cost function.

In some examples according to any method described herein, subsequent maps may relate to a previous map (e.g., a first map, subsequent map or a regional map). In some examples according to any embodiment described herein, subsequent maps may be de novo or naive of any previous maps. For example, a first map of a sample may be processed through the AI model (e.g., the neural network), and an output may trigger the acquisition of a subsequent map. The subsequent map may be a second layer of the first map such that the subsequent map and the first map are substantially the same. In some examples, a subsequent map may have different features such as a different area or region of the map relative to the sample, for example, the subsequent map may substantially repeat the first map or the subsequent map may have a shift from a position of the first map, relative to the position of the sample. In any example or method described herein, subsequent maps may be combinable with previous maps providing layers of information relating to the image or sample. In other examples, the subsequent maps may be processed by the AI model without consideration of previous map processing results.

In some examples of any method described herein, a map may be generated in a sequence relative to the sample in the microscope-based system. For example, a map may be generated in a sequential linear fashion wherein the microscope-based system has an imaging system configured to capture an image of a sample. The imaging system may capture multiple images relating to the same sample. For example, the imaging system may scan the image. In some examples data from the scan or captured image segment may be processed periodically where image segments may relate to the segment or image that is captured at a point of time during the image capture. For example, where any method described herein includes capturing an image with a microscope-based system and the captured image is less than an image of the entire segment as the imaging system is capturing the image, that portion of the image captured may be input into the AI model and processed. In some examples, the image segment is pre-processed for image pixel stabilization prior to being submitted to the AI model. The image segment may be processed according to any method described herein.

In some examples, processing a segment of an image of an entire sample may include inputting the image segment into the input layer of the AI model and the image being data that is processed through the AI model including through one or more hidden layers between the input layer and the output layer. In some examples, an output relating to the processed image segment may trigger or initiate reverse propagation wherein the AI model further processes the image and may trigger additional image capture based on the data derived from processing the image.

In some examples, multiple images of the sample may be captured by the imaging system wherein each of the images captured may be with a different field of view (FOV). Each of the FOVs of the sample may include one or more regions of interest. For example, a first image may be captured having a first FOV, a second image may be captured having a second FOV, a third image may be captured in a third FOV. In some examples, a first FOV may be used when capturing more than one image such that more than one image is captured having a FOV. A second set of images may be captured having a second FOV, each of the images of the second set may be captured with the same second FOV. In some examples, images are captured as part of a set of images wherein each of the images within the set is captured using a FOV that is the same for every image in the set. In some examples, an image set refers to a set of image segments of a sample.

In some examples any method herein may include establishing parameters relating to the AI model training or image processing. The method may include maintaining the parameters once they have been established for subsequent imaging or different fields of view. In other examples, parameters may be changed or adjusted to achieve the desired output. In some examples, the parameters will not change even for different FOV. For example, according to any method herein, initial parameters will not be adjusted using traditional or standard image processing algorithms for each FOV prior to processing the image segmentation process.

Training an AI model for use with a microscope-based system may include developing an architecture of the neural network with determining a number of classes for the output layer. In some examples, the output layer comprises of one or more classes being relative to the number of objects anticipated in the image. In some examples, the number of output classes may be predetermined. For example, a user may establish one or more output classes prior to the image processing according to any method described herein. In some examples, the number of classes is provided or identified by the AI model. For example, the AI model according to any method described herein, may capture an image from a sample with the microscope-based system. During image pre-processing, one or more segmentation methods may identify an initial number of proposed objects and the number of output classes proposed may relate to the number of objects identified during the preprocessing. For example, a sample having some type of tissue may include extracellular structures, different cell types having different morphologies, or distinguishable layers relating to a thickness of the sample. Accordingly, the pre-processing of the sample image may have a one or more outputs for each cell type, each type of extracellular structure, and each layer of tissue.

Training an AI model for use with a microscope-based system may include developing a set of known or validated input data (e.g., data library) that is introduced into the AI model at the input layer such that each input from the data library is processed through the AI model neural network and resulting outputs may be acceptable indication related to the known or anticipated output based on the input from the data library. For example, an image of a plurality of cells comprising epithelial cells with associated cellular junctions (e.g., tight junctions and gap junctions) is selected from the data library to input into the AI model for training related to epithelial cells (e.g., cell junctions). The data library image is input into the input layer of the neural network and processed through one or more hidden layers wherein a weight is associated with each synaptic relationship from one layer to the next. The weights and input numerical values are applied to the activation algorithm and an output is provided relating to the identification of a cell-to-cell junction. In some examples, the output relating to the identification of a cell-to-cell junction is further classified as a gap junction due to the connexons between two cells at a space or a segment of space separating the cells. Accordingly, the output may provide details of the image indicating the presence of one or more gap junctions as well as specific cell type (e.g., endothelial cells), and demarcation of a cell-to-cell contact.

In some examples, the data library is comprised of images compiled from common databases. For example, training of an AI model for use with a microscope-based system may include the development of a data library having acceptable or known images of exemplary structures, relationships, and objects within an image. In some examples, the objects within the image may include known elements used for validating output from the AI model processing. In some examples, the data library includes images captured by the microscope-based system. In some examples, the microscope-based system is in electric communication with a network of microscope-based systems such that the network of microscope-based system compiles a data library of images obtained by each microscope-based system in communication with the network.

In some examples, the data library comprises one or more images or input data obtained by a microscope-based system that has been validated based on the details, characteristics, and attributes of the one or more images. For example, a user may engage a microscope-based system to obtain an image based on a sample introduced therein. The user may approve, acknowledge, or otherwise indicate attributes of the image obtained for classification and storage of the image within the data library such that the image may be utilized in subsequent training of the AI model. For example, where the user introduces a sample of epithelial tissue into the microscope-based system, the user may indicate that it is endothelial tissue, as well as additional information such as the source of the tissue, known history or disease state of the tissue, whether the tissue has been known to previously be in contact with any modifying agents.

In some examples, the data library may include a distinct cell type, a distinct tissue type, a combination to cells, tissues, extracellular material, intracellular material, genetic material, or a derivative thereof. In some examples, the data library may include an image of any sample obtained or appropriate for use in combination with a microscope-based system wherein the data (e.g., the image) has been modified with a stain, probe, marker, or other effector compound to cause a change from a native composition of tissue to a marked, labeled, or tagged composition of tissue. For example, fluorescent probes may be introduced to the sample, prior to the image being taken such that the resulting image (e.g., the input data from the data library) would have a visual indicator of a target or structure associated with the tag that was used.

In some examples of any method described herein, the sample loaded into the microscope-based system is a biological sample (e.g., a sample derived from a eukaryote). In some examples of any method described herein, the sample loaded into the microscope-based system is a biological sample (e.g., a sample derived from a prokaryote. In some examples of any method described herein, the sample loaded into the microscope-based system is a non-biological sample (e.g., a sample derived from a non-living source). In some examples of any method described herein, the sample loaded into the microscope-based system is a combination of any of the samples, segments of samples, portions of samples, or other related sample to those described herein.

Training the AI model, according to any method described herein, may include a combination and memory of training of the AI model based on validated examples used for training. A validated example (e.g., an example from the data library), may be used to train the AI model on one or more elements that may be introduced to the AI model from the image captured by the microscope-based system. As the AI model is trained on a validated example of known regions of interest and the AI model adapts or evolves to include modification relating to the training from the validated sample, the AI model may be trained to recognize relevant structures of an input image and adapt to the input image based on the recognized structures. For example, where the image captured by the microscope-based system includes cells, the AI model may be trained to recognize the presence of cells within the image and adjust the processing algorithms to increase processing efficiency relating to cellular associated regions of interest. Another example may be where the image captured by the microscope-based system includes layers of tissue, the AI model may adapt processing algorithms of the one or more hidden layers in preparation of analyzing a tissue sample for improved processing times. The alternative may be subjecting input data from a captured image to an AI model comprising training of all potential elements of the image and the AI system having to process all potential outputs, instead of those outputs relating to the elements within the captured image.

In some examples, the microscope-based system may subject an image captured therein to a first AI model trained on sample identification having outputs relating to the classification or identification of the sample type. A second AI model may then be initiated based on the type of sample identified in the output values of the first AI model. For example, An AI model may identify the input sample from the microscope-based system as a tissue sample and may exclude algorithms and processing relating to irrelevant elements of the image. In other examples, the AI model may be segmented such that the input layer receives data from an image captured by the microscope-based system and the AI model processes the input data sufficiently to identify a sample type. Remaining segments of the same AI model may continue processing through hidden layers adapted to analyze elements and attributes of the image data relevant to the identified sample type. In some examples, the AI model comprises a network of sub-models that are trained on different classifications of sample types or attributes. Accordingly, processing of an image through the AI model network may include sequential processing of the image input data through the network of sub-models based on output values from preceding processing models.

In some examples, any method described herein may incorporate a data input (e.g., an image or image pixel) that was previously modified by one or more compounds to highlight, tag, or identify a structure therein. In such examples, the AI model may be trained using data from the data library that relates to more than one attribute of the AI processing requirements. For example, where a sample has been labeled with a stain that is taken in by a cell or by a cellular component, the data from the data library used to train the AI model to process new samples of a similar composition and presentation may be a similar stain. In this way, any of the methods described herein may be used after a sample or image (e.g., data input) has already been modified.

In some examples, the methods described herein may be used for multiplexing or multi-output recognition of more than one feature, object, or region of interest of the input data (e.g., the captured image). For example, a cell having a stain previously applied is introduced to the microscope-based system. An image is captured of the stained cells and the image is processed by any of the methods described herein. According to the attributes of the objects within the image (e.g., the data input for processing), the AI model may generate more than one output indicating multiple aspects of the image. For example, the stain may relate to one output, the cell type may relate to another output, cell-to-cell interaction may relate to another output, cell membrane morphology may relate to another output, a disease state of the cell or input data may relate to another output.

In some examples, the number of outputs may be selectable in determining the architecture of the neural network. In another example, according to any method described herein, the number of outputs may be selectable after the image from the microscope-based system has been processed through the AI model. For example, the AI model may provide for more than one out value indicating a particular data attribute of the input. In such an example, the number of outputs resulting from the AI processing may be more than the number of outputs required for consideration by the user. Accordingly, the user may select fewer than the number of available outputs.

In some examples, the neural network architecture is dynamic and modified based on the number of predetermined or selected outputs. For example, the number of layers (e.g., hidden layers) between the input layer and the output layer may be related to the number of outputs required for the AI model to generate. Accordingly, by modifying a quantity of output possibilities, the number of hidden layers may increase or decrease accordingly.

In some examples, the input data (e.g., an image obtained from a microscope-based system) may be pre-processed. Pre-processing of the input data may relate to one or more modifications or changes between obtaining the data and inputting it into the AI model. For example, pre-processing may include image pixel standardization relating pre-processing of pixel values of the image before the image is submitted as an input into the ANN. For example, an image obtained from a microscope-based system may include a 16-bit image initially obtained. The 16-bit image may have quantifiable values for each pixel of the image that range between a minimum pixel value of the image to a maximum pixel value of the image. In some examples, pre-processing methods of an image obtained from a microscope-based system may relate to adjustments of unforeseeable differences or aberrations of the sample input. For example, discrepancies in the image obtained from a microscope-based system may be attributed to malfunctions in the equipment, components, or operation of the microscope-based system. Accordingly, pre-processing of the image may result in a standardization of image pixel values that may compensate for the discrepancy and increase the processing efficiency of the neural network in generating a mask pattern from the input data.

In some examples, the pre-processing may reduce the amount of algorithm processing by the neural network. Pre-processing an image obtained from a microscope-based system may standardized the image pixel values across the image or an identified region of interest. Standardizing the image pixel values may provide for input data configured to be input into a neural network. For example, each pixel of an image obtained from a microscope-based system may be quantified (e.g., related to application of a histogram to the obtained image) and the numerical representation of each pixel may serve as an input data for the neural network. Where the image obtained from the microscope-based system has been pre-processed to standardize the image pixel values, fewer algorithms within the hidden layers of the neural network may be required to process the data for a validated output. For example, a pre-processed image may require fewer incidence of propagation through the activation algorithms to achieve a valid output. In some examples, the pre-processed image may reduce the number of hidden layers required to process the input image through the trained AI model.

In some examples according to any method described herein, the method may include an image standardized method process before any image segmentation processes or AI model inference (e.g., prediction) in generating a mask pattern for photochemical illumination. Image segmentation may refer to a computer-based operation of labeling individual pixels of one or more objects or regions of an image. For example, semantic segmentation may relate to classification of each pixel of the image relative to an object, target or region of interest therein. In some examples, the semantic segmentation labels a pixel in a specific class or set of classes that may relate to predetermined distinguishable features of the pixel and the object comprising the pixel.

In some examples of image segmentation described herein, a segmentation map may be generated using one or more layers relating to a single image. Each of the one or more layers may relate to a specific object or region of interest within the figure such that the map layers may each represent segmentation of an object within the image based on pixel classification for pixels comprising the object. For example, a single cell may have intracellular structures such as a nucleus, Golgi body, mitochondria, vacuoles, proteasomes, transmembrane proteins, and a fibrous mesh network throughout. According to some methods described here, a microscope-based system may capture a first image of the cell, including one or more cellular structures within the image. The first image may then be input into a well-trained AI model, as described herein, and output values may be generated based on the different image pixel values derived from the first image. A second image may be obtained and processed through the well-trained AI model such that output values may be generated based on the different pixel values derived from the subsequent image. The output values may be compared to one another for accuracy and consistency of the output values relating to the multiple images subjected to the AI model.

Image segmentation processes may be composed of one or more image processing algorithms. This may cause this image segmentation process to only handle more specific cases. The input cases may be influenced by many attributes, such as clarity, contrast and brightness.

According to any method described herein, the image segmentation process may be capable of evaluating more cases associated with artificial operations, machine problems or any other reason. In some examples, an image pixel standardized process for input image before processing image segmentation process may be necessary.

In some examples according to any method described herein, a system may include functional components configured to obtain an image from a microscope-based system. For example, a microscope-based system as described U.S. Patent Publication US 20180367717 A1 having an illumination assembly and imaging assembly calibrated to the microscope. A camera suitably positioned within the microscope to obtain an image of a sample (e.g., a biological sample introduced to the microscope). The microscope-based system may be configured to obtain an image having a quantifiable bit-depth. For example, the bit depth of the image obtained by the microscope-based system may have a bit depth of 1-bit, 2-bit, 3-bit, 4-bit, 8-bit, 16-bit, 32-bit, 64-bit, 128-bit or any bit depth within a range of greater than 0 to 128-bit. In some examples, the bit depth may be greater than 128-bit. In some examples, the bit depth of the image obtained from the microscope-based system may be a bit depth related to the capabilities of the imaging assembly, illumination assembly, camera, or other elements of a microscope-based system.

In some examples according to any method described herein, a mask may be generated based on the output or results of the image processing algorithms as the AI model or machine learning evaluates inputs against one or more layers of a deep learning neural network. For example, the mask is generated based on the input of an image that is processed through one or more layers of an AI model (e.g., neural network). The image may be processed through the developed architecture of the neural network and a mask may be generated based on the image processing.

In some examples according to any method described herein, a mask may be predicted by an AI model that has been trained on related data to the input. The AI model may be trained using similar or related data inputs of known values with anticipated outputs relating to mask generation. After the AI model has been sufficiently trained and the bias or weight values have been properly calibrated, new data (e.g., an image captured from a microscope-based system) may be introduced to the AI model that is able to predict the output on initial presentation of the data. The predicted output may then be used to develop a mask configured to be applied to the data (e.g., the image captured from the microscope-based system). In some examples, the mask relates to a region of interest of the image and the mask covers non-target regions or only exposes the region of interest. A light source may then emit light onto the mask such that the unmasked portion (e.g., the region of interest) is illuminated.

In some examples according to any of the methods described herein, the AI model architecture may include multiple layers. Each of the multiple layers may perform a different function relating to the processing of the image. Some examples of the different layers within the AI model may be pooling layers, convolutional layers, fully connected layers, classification layers, normalization layers. Arrangement of layers throughout the neural network architecture may be developed based on the desired function and capabilities of the AI model and the microscope-based system.

In some examples of any methods described herein, a U-net neural network may be a segmentation mechanism for processing data (e.g., an image) obtained from a microscope-based system. The U-net processing may include the step of developing a pre-processed image. In some examples, developing a pre-processed image may include pre-processing the image to standardize the image-pixel values from a first image obtained by the microscope-based system to a pre-processed image having standardized image pixel values. For example, the standardized image pixel values may have a standardized distribution or mean of 0 across all the image pixel values of the image. In some examples, the pre-processed image is an 8-bit image whereby the initially obtained image was a 16-bit image. In some examples, pre-processing methods may be based on the input data (e.g., the image being processed by the AI model. For example, pre-processing may relate at least to pre-processing the data intensity, normalization, resampling, or standardizing and pre-processing other features of the data to be introduced to the U-net AI model. The method may also include designing or selecting a neural network architecture (e.g., an architecture of the U-net). For example, the patch size of the input (e.g., image obtained from the microscope-based system), the number of pooling layers, the organization and quantity of convolutional layers. The method may also include the step of defining loss functions, batch sizes, learning rates, and other parameter functions.

In some examples according to any method described herein, consideration of hardware may contribute to the design and training of the AI model. For example, capacity of processing units and storage may be considered when developing the AI model architecture and the neural network selection. The method may also include a validation of the training to analyze the process of the AI model. For example, after the AI model has been established and training is implemented, according to any method described herein, output and operation may be evaluated to ensure the AI model is optimized.

In some examples, pre-processing of images captured by a microscope-based system may be necessary for accurate and efficient function of the image segmentation by the AI model. Optimizing image segmentation processes may increase image segmentation capabilities. Described herein may be methods that improve image processing and pre-processing. For example, methods described herein may optimize and provide improved image processing and pre-processing compared to brightness or contrast image analysis.

A method for processing an image obtained from a microscope-based system for photochemical illumination may include first obtaining the image using microscopy or a technique including the use of a microscope-based system. The image obtained is used to determine the location of the image or features on the image being located at some area within the entire image that is subject for further processing. In some examples and according to any method described herein, recognition of these areas may be accomplished by one or more image segmentation techniques (e.g., semantic segmentation, instance segmentation or object segmentation) using deep learning. A mask may be generated based on the deep learning (e.g., AI model) output. The generated mask may be applied to the image and a light may be shined through the mask and into the target zone exposed by the mask. The light may illuminate the region within the mask. For example, the light may have a wavelength sufficient to illuminate objects, structures, or features of the image exposed by the mask.

In some examples according to any method described herein, the AI model is configured to process an image that has been standardized. For example, A method for standardizing image pixel values from an image obtained by a microscope-based system may include first using the microscope-based system to capture an image. Then, the process may include applying a histogram to the image. Pixel values may then be analyzed. For example, each pixel may have a value relating to the range of color within a pixel. The pixel values may be quantified and a range of pixel values may have a minimum pixel value and a maximum pixel value. Then a transformation method may be selected or established. The transformation method selection may be based on one or more characteristics of the pixel value data set. For example, the transformation method may be based on a slope and speak of a trend defined by the range of values between the minimum value and the maximum value. In some examples, the transformation method may be a linear transformation method (e.g., Linear transformation, Linearity transformation, multi-order linear transformation, Sigmoid fit theory transformation). In some examples, the transformation method may be a non-linear transformation method (e.g., Modified Sigmoid fit theory transformation). In some examples, Modified Sigmoid fit theory transformation is a hybrid transformation method between nonlinear transformation and linear transformation. In some examples, the method for standardizing image pixel values from a microscope-based system may result in the initially obtained image from a microscope-based system to be transformed through the selected transformation method from a first bit depth to a second bit depth. For example, the initial image obtained from a microscope-based system may be a 16-bit image. The selected transformation method may be applied to the initial image obtained from a microscope-based system, thereby converting the 16-bit initial image to an 8-bit pre-processed image having standardized pixel values resulting from the selected transformation method.

In some examples, the pre-processing methods described herein are configured to optimize an image for processing with a well-trained AI model. For example, the methods described herein may optimize the resulting converted images for a specific image or a specific sample or a specific region of an image (e.g., a region of interest). In some examples, the initially obtained image may be an entire image obtained by the microscope-based system. In some embodiments, the initially obtained image may be less than the entire image initially obtained image from the microscope-based system. For example, a specific region of an image may be selected then the specific region may be evaluated, and a range of pixel values of the specific region may be determined. The specific region may then be subjected to the selected transformation method according to the range of pixel values therein between a minimum pixel value of the specific region and a maximum pixel value of the specific region.

According to some examples described herein, the microscope-based system initially captures a 16-bit image. After drawing the histogram by the image, the pixel values obtained may be distributed within a range of values between a minimum pixel value and a maximum pixel value. The distribution of the pixel values other than the minimum pixel value and the maximum pixel value may be smaller than half, smaller than one third, smaller than one fourth, or smaller than a fraction of the maximum image pixel value provided by initially obtained 16-bit image. The distribution of the pixel values of the initially obtained image may be due to an intensity level of a signal for fluorescence excitation. In some examples, the level of intensity for florescent excitation may be high or low and the level of intensity may impact the distribution of the pixel values throughout the range of pixel values of the initially obtained image. In some examples, the initially obtained image captured by microscope-based system may be observed to be light or dark or a similar description regarding the image between light or dark.

In some examples, additional processing with a well-trained AI model may result in the identification of target biological activity or elements observable within the image. For example, the image may contain multiple cells that may interact with one another. After the image has been pre-processed and the image pixel values standardized by a method, described herein, the AI model may process the image to highlight or indicate cell-to-cell interactions. In some examples, cell-to-cell interactions may include intercellular junctions (e.g., gap junctions or tight junctions); in some examples, the cell-to-cell interaction may include transmission of cytokines between the cells observed in the image; in some examples, the AI model may process the image to highlight cellular activity such as apoptosis or cellular lysate; in some examples, the AI model may process the image to highlight phagocytotic acidity of myeloid cells; in some examples, the initially obtained image includes one or more neurons and the AI model highlights the transmission of signaling through and between one or more neurons (e.g., neurotransmission) in some examples, the AI model may process the image to highlight transportation or endocytosis by individual cells of extracellular material into the cell; in some examples, the AI model may process the image to highlight extracellular or intracellular concentrations or presence of a therapeutic compound; in some examples, the AI model may process the image to highlight intracellular activity such as intracellular metabolism, respiration, cell signaling processes, protein synthesis, collagen matrices, and other targeted cellular activity or function.

In some examples, any method described herein may include or relate to semantic segmentation. Validated or known examples of an image, component element, or region of interest relating to known or expected attributes of an image captured by a microscope-based system may be used to train the AI model. For example, exemplary images are first labeled with known location, size, dimensions, proximity to another known compliment element, etc. These exemplary images may then be introduced to an AI model for training. The AI model may further be configured or calibrated by user interaction such that regions of interest of the image captured by the microscope-based system may be identified on the captured image and those areas of the captured image containing the regions of interest may be processed though the AI model according to any method described herein.

In some examples of the methods and systems described here, the AI model may be trained to detect and segment objects within an image of a sample obtained from a microscope-based system. For example, cellular morphology relating to the surface area of a cell or specific objects within the cell (e.g., nuclei) may be indicative of a stage of category of classification for a disease type.

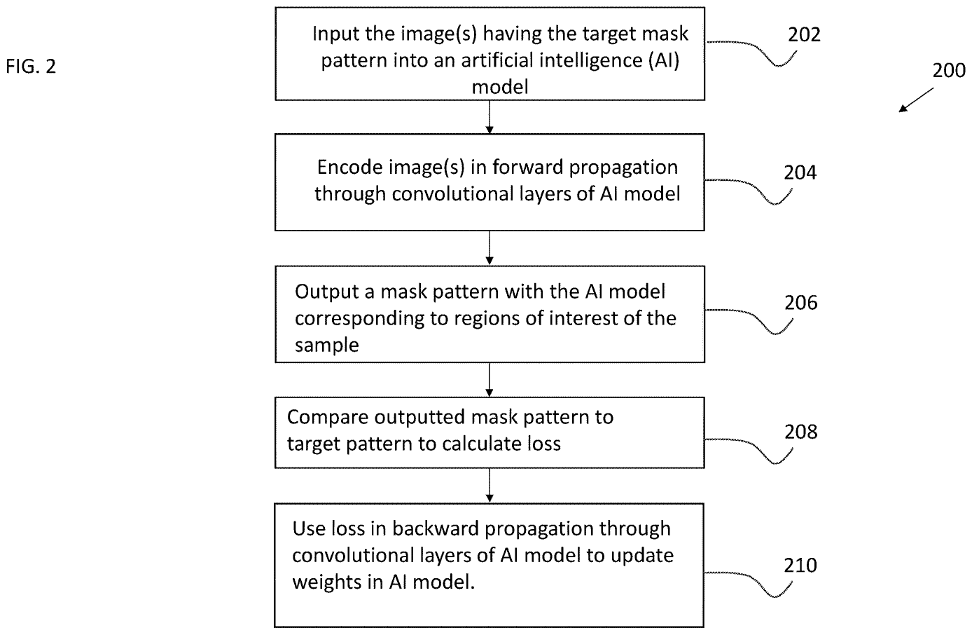

In one example, referring to FIG. 2, a method 200 of training an AI model to output a mask pattern corresponding to regions of interest of a sample of a microscope-based system may include obtaining one or more images of the sample with the microscope-based system. Obtaining the images can comprise obtaining the images with an image capture system of the microscope-based system. The images can correspond to one or more target fields of view (FOV) of the sample. The images can have a target mask pattern that corresponds to one or more regions of interest of the sample in the target FOV.

At an operation 202, the method 200 can include inputting the image(s) having the target mask pattern into an artificial intelligence (AI) model. At an operation 204, the method can include encoding the image(s) in forward propagation through the convolutional layers of the AI model.

At an operation 206, the method can include outputting a mask pattern with the AI model corresponding to regions of interest of the sample. At an operation 208, the method can further include comparing the outputted mask pattern to the target mask pattern to calculate a loss. The loss can comprise, for example, a difference between the outputted mask pattern and the target mask pattern.

At an operation 210, the method can further include using the loss in backwards propagation through the convolutional layers of the AI model to update weights in the AI model.

The AI model can be further trained by repeating some or all of the operations described above. For example, after weights have been updated in operation 208, the method can be repeated with additional training images. Each iteration of forwards and backwards propagation through the convolutional layers of the AI model results in updated weights that further improves the output mask pattern. Ultimately, the AI model is fully trained when the output mask pattern corresponds to the target mask pattern, or until the loss calculated between the output mask pattern and the target mask pattern is below a loss threshold (e.g., less than 1% loss, less than 5% loss, less than 10% loss, etc.).

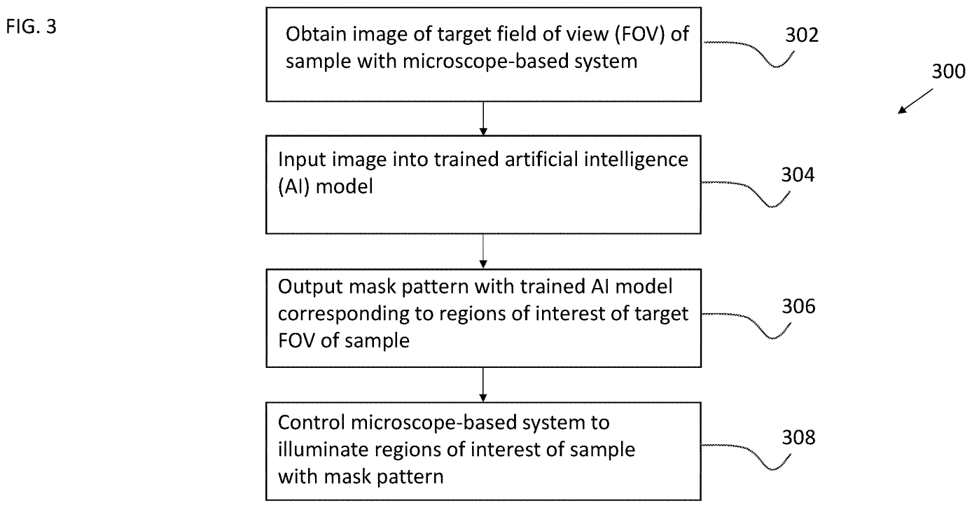

FIG. 3 illustrates a flowchart 300 that describes a method for generating a mask for pattern-illumination of a sample using a microscope-based system. At an operation 302, the method can include obtaining one or more images of the sample with the microscope-based system. Obtaining the images can comprise obtaining the images with an image capture system of the microscope-based system. The images can correspond to one or more target fields of view (FOV) of the sample. The images can have a target mask pattern that corresponds to one or more regions of interest of the sample in the target FOV.

At an operation 304, the method can include inputting the one or more images into a trained artificial intelligence (AI) model, such as the model described above in FIG. 2 or any other AI model described herein.

At an operation 306, the method can further include outputting a mask pattern with trained AI model corresponding to regions of interest of a target FOV of sample.

Next, at an operation 308, the method can include controlling a pattern illumination system of a microscope-based system to illuminate regions of interest of sample with the outputted mask pattern.

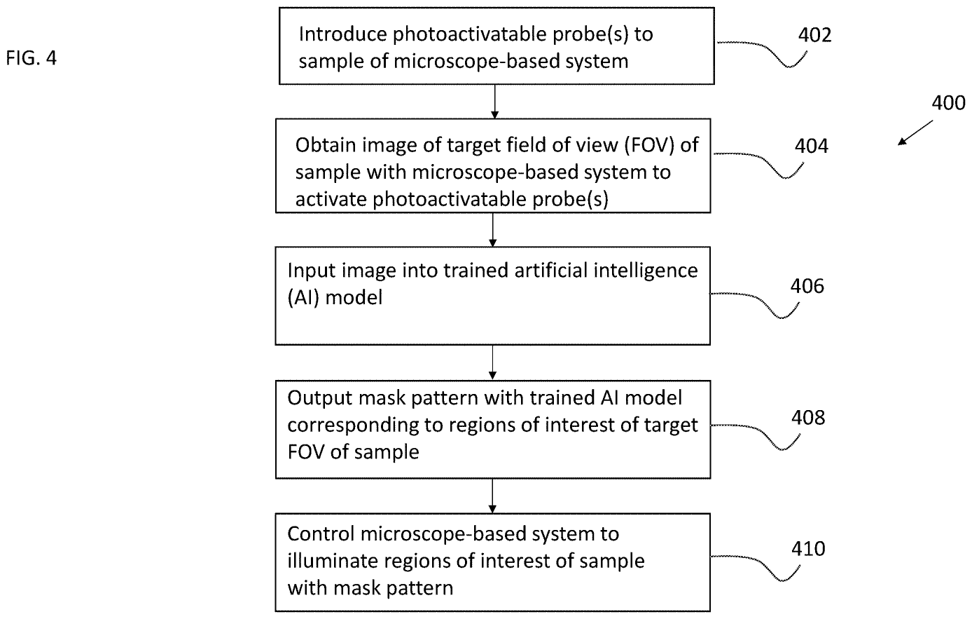

FIG. 4 illustrates a flowchart 400 that describes another method for generating a mask for pattern-illumination of a sample using a microscope-based system. At an operation 402, one or more photoactivatable probe(s) can be introduced to a sample of a microscope-based system.

At an operation 404, the method can include obtaining one or more images of the sample with the microscope-based system to activate the one or more photoactivatable probe(s). Obtaining the images can comprise obtaining the images with an image capture system of the microscope-based system. The images can correspond to one or more target fields of view (FOV) of the sample. The images can have a target mask pattern that corresponds to one or more regions of interest of the sample in the target FOV.

At an operation 406, the method can include inputting the one or more images into a trained artificial intelligence (AI) model, such as the model described above in FIG. 2 or any other AI model described herein.

At an operation 408, the method can further include outputting a mask pattern with trained AI model corresponding to regions of interest of a target FOV of sample.

Next, at an operation 410, the method can include controlling a pattern illumination system of a microscope-based system to illuminate regions of interest of sample with the outputted mask pattern.

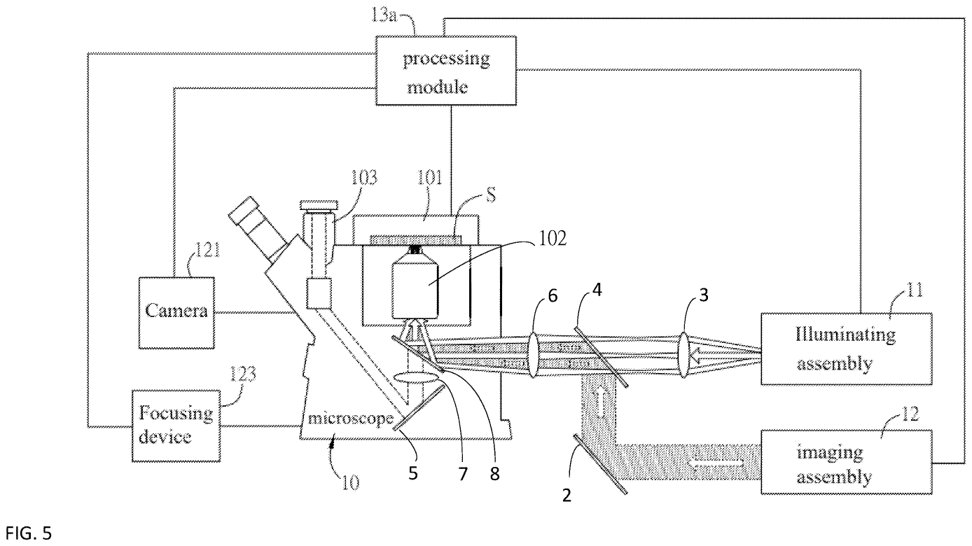

FIG. 5 illustrates an example of a microscope-based system that may be configured to use any of the AI generated masks for pattern illumination as described herein. Additional details of the microscope system may be found in U.S. Pat. No. 11,265,449, incorporated herein by reference in its entirety. The microscope-based system of this embodiment comprises a microscope 10, an imaging assembly 12, an illuminating assembly 11, and a processing module 13a. The microscope 10 comprises an objective 102 and a stage 101. The stage 101 is configured to be loaded with a sample S. The imaging assembly 12 may comprise a (controllable) camera 121, an imaging light source, and a focusing device 123. The processing module 13a can include one or more processors configured to carry out the processes and methods described herein. In some examples, the processing module 13a can include one or more trained AI models configured to produce a mask pattern corresponding to one or more regions of interest in a sample.

The stage 101 can be moved to provide different fields of view of the sample S. The sample S may comprise, for example, a fluorescent sample, a reflective sample, or a sample that can be marked by the light projecting from the imaging subsystem. For example, the sample mark can be bleached, activated, physically damaged, or chemically converted. The mark can be analyzed by the imaging subsystem, and the position of the mark may be represented by the result of the projected light.

In some embodiments, as described in U.S. Pat. No. 11,265,449, images obtained by camera 121 can be processed in a processing subsystem 13a to identify regions of interest in the sample. For example, when the sample contains cells, particular subcellular areas of interest can be identified by their morphology. In some embodiments, the regions of interest identified by the processing module from the images can thereafter be selectively illuminated with a different light source for, e.g., photobleaching of molecules at certain subcellular areas, photoactivation of fluorophores at a confined location, optogenetics, light-triggered release of reactive oxygen species within a designated organelle, or photoinduced labeling of biomolecules in a defined structure feature of a cell all require pattern illumination. The AI-models described herein may create or generate a pattern or mask for pattern illumination. The embodiment of FIG. 1 therefore has a pattern illumination assembly 11 which projects light corresponding to the AI-generated pattern or mask onto sample S through a lens 3, mirror 4, lens 6, and mirror 8. In some embodiments, pattern illumination assembly 11 employs a laser to illuminate through the pattern of the region of interest in the sample S by moving mirror within the pattern illumination assembly 11.

The microscope, stage, imaging subsystem, and/or processing subsystem can include one or more processors configured to control and coordinate operation of the overall system described and illustrated herein. In some embodiments, a single processor can control operation of the entire system. In other embodiments, each subsystem may include one or more processors. The system can also include hardware such as memory to store, retrieve, and process data captured by the system. Optionally, the memory may be accessed remotely, such as via the cloud. In some embodiments, the methods or techniques described herein can be computer implemented methods. For example, the systems disclosed herein may include a non-transitory computing device readable medium having instructions stored thereon, wherein the instructions are executable by one or more processors to cause a computing device to perform any of methods described herein.

The following examples included herein show, by way of illustration and not of limitation, specific embodiments in which the subject matter may be practiced.
Example 1: A tissue sample is loaded into a microscope-based system. The tissue sample comprises cells and structures that may be visible in an image of the sample obtained by the image capturing system of the microscope. The captured image is pre-processed and image pixel values of the captured image are transformed to standard values relative to one another. The image pixel values of the pre-processed image are then input into an AI model that has been trained. The AI model processes the input data regarding the image pixel values of the pre-processed image. Output values are generated relating to the identification of image pixel values associated with regions of interest in the sample. The output values are used to generate a mask used for illumination of the sample in the exposed areas of the mask that highlight the region of interest.
Example 2: A sample of cells from the immune system are cultured with a bacteria. The cultured cells are introduced to the microscope-based system and an initial image is obtained showing multiple cells at various stages of phagocytosis. The image is pre-processed to standardize image pixel values and the pre-processed image is then introduced to the well-trained AI model. The AI model may be trained using validated examples of similar cells and similar phagocytotic activity. According to the training of the AI model, the neural network of the AI model processes the pre-processed image to provide output values relating to regions of interest within the initial image. A mask is generated using the output values and the mask exposes the regions of interest (e.g., contact of a bacterial by an immune cell). The microscope-based system is then used to generate a light emitted from the illumination system of the microscope. The illumination system is configured to highlight the regions of interest within the mask and the image is transformed to highlight the areas and cells that are undergoing stages of phagocytosis.
Example 3: A patient-derived sample is introduced into a microscope-based system having a plurality of cells distributed throughout the image. The microscope-based system is configured to capture images of intracellular components including components of the ubiquitin processing system (UPS). Multiple images of the sample are captured by the microscope-based system and pre-processed to standardize image pixel values. Each of the images are used as input data where the image pixel values are processed through the AI model that has been trained with validated examples of proteasome activity. Output values are generated relating to those pixels within the image containing or presenting proteasome or (UPS) activity. The output values of each image captured from the same sample are evaluated and a mask is generated based on the reconciliation of all of the images processed through the AI model. The mask is applied to the sample and UPS components are identified using illumination techniques. The quantity and observed activity of the UPS components may be used for diagnostic purposes relating to UPS activities.
Example 4: A patient has not responded to a targeted therapeutic regiment. Samples derived from the patient are introduced into the microscope-based system where images are captured. The images may be pre-processed and image pixel values can be standardized. The pre-processed images are then introduced to an AI model trained on validated examples of the structural targets of the therapeutic regiment. Output values are generated relating to the structural targets and a mask may be generated to highlight those targets for illumination. The mask may provide for a limited or non-existent incidence of the structural targets. Accordingly, a false-positive may be considered relating to the limited or non-existent structural targets of the therapeutic.
Examples 5: A sample is introduced to a microscope-based system and multiple images are obtained by the system of the sample. The images obtained may include images of different fields of view of the same sample. The images may be pre-processed and introduced to a well-trained AI model that has been trained on validated examples of cell-to-cell contact (e.g., junctions between two or more cells). Output values are generated, and a mask is developed using the generated output values to highlight the areas of the image including cell-to-cell contact. These highlighted areas may then be illuminated within the microscope-based system such that the cell-to-cell contact is illuminated with a different color of light or different intensity of light from the microscope-based system.
Example 6: A microscope-based system scans a biological sample and captures an image through progressive scanning of the image. As the image is scanned, pixel values from the scan may be introduced into an AI model, as described herein, in real-time relating to the progression of the image scan. The pixel values are processed by the neural network and output values are generated. The AI model may be trained with validated examples of sample-associated regions of interest and as the pixel values are processed by the AI model, output values are generated relating to the presence of one or more of the regions of interest. A mask may be generated according to the output values relating to the regions of interest and a resulting processed image may be segmented to highlight the regions of interest as the image is scanned by the microscope-based system.
Examples 7: A sample is introduced to a microscope-based system. An image is captured of the sample and pro-processed to standardize the image pixel values. The standardized image pixel values are introduced to the AI model and output values are generated. The AI model may be trained using related validated examples of the regions of interest sought in the captured image. After a first processing within the neural network, additional output values may be required relating to the same image. The AI model me trigger a subsequent image or subsequent evaluation of the pixel value input data and additional processing of the image may proceed to generate additional output values for a comprehensive identification of the regions of interest. A mask may then be generated based on the output values. The mask may then be applied to the image or sample and subjected to illumination with one or more lights to visually identify the regions of interest within the sample.
Example 8: A fluid sample from a knee of a patient having rheumatoid arthritis (RA) is loaded into a microscope-based system. The microscope-based system captures an initial image of the sample with sufficient resolution to generally identify cells and related activities. A computer-based system within the microscope-based system is initiated to pre-process the image and standardize the pixel values across the image. The pre-processed image is then input into a well-trained AI model operating within the computer-based system. The image input is subjected to semantic segmentation resulting in pixel classification of various cell types. The AI model may have been trained using validated examples of cells and sell activity in fluid of rheumatoid arthritis. A mask is generated to identify and segment each of the different cell types. Accordingly, the segmented cell types may be illuminated and observed to include white blood cells and a high concentration of metacarpal phalangeal joint specific fibroblast-like synoviocytes, generally indicating metacarpal phalangeal joint RA. Treatment may be adjusted for improved response based on the metacarpal phalangeal joint specific FLS from the knee sample.
Example 9: A patient having non-small cell lung cancer with a DNA mutation in a gene encoding PDL-1 was previously evaluated with next generation sequencing (NGS) to identify the DNA mutation. A tissue sample was loaded onto the microscope-based system and an image was obtained showing details of malignant cells. The image was pre-processed according to a method described herein to standardize the image pixel values from the initially obtained image. The pre-processed image was then input into the AI artificial neural network within the computer-based system of the microscope-based system. The image was subjected to semantic segmentation identifying malignant cells and the AI model further processed the image through multi-layer semantic segmentation to segment and detect surface markers on the cell surface. Accordingly, the AI model generated a mask based on the input to highlight the pixels of objects on the cell surface. The neural network processing identified functional PDL-1 kinases on the cell surface. Further, the AI model identified immune cells contacting the cell surface through PD1-PDL1 binding interactions. The output layer highlighted the regions of interest based on the training developed for the AI model to identify immune checkpoint activities.
Example 10: An unknown sample is introduced to a microscope-based system and an image is captured. The image is standardized regarding the image pixel values. The standardized image is input into a well-trained AI model that has been trained on multiple regions of interest including structures, function, and activities of cells and components included in the image. The AI model processes the image and presents output values with associated regions of interest. A user then selects one or more of the regions of interest identified in the generated output values that are used to generate a mask relating to the unknown sample. The mask is applied to the sample and regions of interest are exposed and highlighted. Based on the nature of the illuminated regions of interest, determination regarding the sample can be made.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

Any of the methods and/or systems described herein may be associated with illuminating an image, picture, photograph, etc. For example, photo illumination may refer to an illuminating unit supplying illumination to an image of a sample such that a target, region of interest, and/or area of the image is selectively illuminated. In some examples, a region of interest is targeted, and the photo illumination of that desired region may be accomplished by the generation of a mask or pattern (e.g., generated by a trained AI platform) that can be applied to a sample or image to selectively target and illuminate one or more regions of interest.

In some examples described here, one or more methods or system may relate to the use, interaction, training and/or development of an artificial intelligence (AI) system. AI may refer to machine learning, deep learning, neural networks, etc. AI may refer to a combination of one or more artificial intelligent processing systems. For example, the AI system may relate to an artificial neural network such as a Convolutional Neural Network, Modular Neural Networks, Feedforward Neural Network—Artificial Neuron, Radial basis function Neural Network, Kohonen Self Organizing Neural Network, Recurrent Neural Network(RNN), Long/Short Term Memory or others. The ANN may be described to relate to the physiological activity of a neuron. For example, a native neuron may receive information as an input at a first position or end of the neuron (e.g., an end of a neuron having dendrites that are configured to receive information (e.g., neurotransmitter) and process that information along the body of the neuron (e.g., the axon) towards the axon terminal end where the neuron may produce transformed information relating to the metabolism, transmission, or propagation of the chemical information received at the dendrites. The transformed information may then be released at or through the axon terminal. In a similar conceptual manner, an artificial neural network (e.g., ANN) may receive an input of some kind of data (e.g., an image obtained from a microscope-based system) that is received into the ANN and processed through one or more intermediary algorithms. The input data may be transformed through the one or more intermediary algorithms such that resulting transformed data through the ANN has one or more different characteristics or attributes, but relating to the input data.

According to any method described herein, layers of an AI model may include one or more layers having different attributes or properties relating to the configuration for transforming data processed therethrough. For example, layers may be convolutional layers, max-pooling layers, average pooling layers, batch-normalization layers, activation function layers. In some examples, the layers may comprise a plurality of layers. For example, layers may include a combination of at least two or more layers, as described herein.

In some examples, the dataset to be processed by or a dataset that has been processed by the AI model, according to any method described herein, may be validated against a model output. For example, a validation of the dataset may include calculating a difference between the model output and the annotated results of the AI processing. In some examples, the training of the AI model includes an evaluation process after the training data has been run or processed by the AI model. For example, an operator (e.g., a user) may evaluate the results of the processed training data run through the AI model. For example, training data may be introduced to the AI model, as described herein. The training data may be processed through one or more layers of the AI model and the resulting data may be evaluated. Based on the evaluated data, variables of the AI model algorithms (e.g., one or more of the algorithms operating within the AI) may be adjusted based on the evaluation of the processed training data.

Any of the methods described herein may include first, obtaining an image captured by a microscope-based system, wherein each of the image has a corresponding target pattern which is annotated according to regions of interest and thus we have two images. The first one is the original image and second one is a mask (e.g., a target pattern), which is annotated by an expert. The step of introducing to the AI-model architecture the image to obtain an output and assessing the output of the image against the corresponding target pattern is the evaluate step of the training circle shown in the figure. The phrase of determining weights (e.g., variables) of the AI model architecture is the variables adjusting step of the training circle shown in the figure.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The processor as described herein can be configured to perform one or more steps of any method disclosed herein. Alternatively or in combination, the processor can be configured to combine one or more steps of one or more methods as disclosed herein.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

1-11. (canceled)

12. A method for photochemical illumination using a trained artificial intelligence model to generate a mask for pattern-illumination of a sample in a microscope-based system, the method comprising:
capturing a first image of a target first field of view (FOV) of a sample with an image capture system of a microscope-based system;
inputting the first image into a trained artificial intelligence model;
outputting a first mask pattern with the trained artificial intelligence model corresponding to one or more regions of interest in the first field of view; and
controlling an illuminating assembly of the microscope-based system to illuminate the one or more regions of interest of the first field of view of the sample with the mask pattern,
after the one or more regions of interest of the first field of view have been fully illuminated by the illuminating assembly, move to the subsequent field of view of the sample to capturing subsequent images of the subsequent field of view;
inputting the subsequent image into the trained artificial intelligence model;
outputting the subsequent mask pattern with the trained artificial intelligence model corresponding to one or more regions of interest in the second field of view; and
controlling an illuminating assembly of the microscope-based system to illuminate the one or more regions of interest of the subsequent field of view of the sample with the mask pattern.

13. The method of claim 12, wherein the trained artificial intelligence model is trained by the following steps comprises:
obtaining a training image of a sample captured by a microscope system, wherein the training image has a target pattern corresponding to regions of interest,
inputting the training image to an input layer of an artificial intelligence model architecture having a number of layers between the input layer and an output layer;
outputting a proposed pattern corresponding to the regions of interest with the output layer of the artificial intelligence model architecture;
comparing the proposed pattern against the target pattern to calculate a loss between the proposed pattern and the target pattern;
updating weights in the layers of the artificial intelligence model architecture based on the calculated loss; and
repeating the inputting, outputting, comparing, and updating steps until the calculated loss is below a loss threshold.

14. The method of claim 12, wherein before inputting the first image and the subsequent images into the trained artificial intelligence model, the method further comprises standardizing image pixel values of the first image and the subsequent images.

15. (canceled)

16. The method of claim 12, wherein the trained artificial intelligence model is configured to segment the one or more regions of interest from pixel value data of the first image and the subsequent images.

17-18. (canceled)

19. The method of claim 12, wherein before capturing the first image of the first field of view, the method further comprises introducing one or more photoactivatable probes to the sample, wherein the one or more photoactivatable probes is configured to bind to one or more regions of interest of the sample and wherein the one or more probes are reactive to light by the illuminating assembly.

20. A method for photochemical illumination generating a mask pattern using a trained artificial intelligence model in a microscope-based system, the method comprising:
capturing a first image of a first field of view of the sample with an image capture system of the microscope-based system;
inputting the first image into a trained artificial intelligence model to obtain initial parameters;
outputting a first mask pattern with the initial parameters corresponding to one or more regions of interest in the sample; and
controlling an illuminating assembly of the microscope-based system to illuminate the one or more regions of interest of the first field of view of the sample with the mask pattern;
after the one or more regions of interest of the first field of view have been fully illuminated by the illuminating assembly, move to the subsequent field of view of the sample to capturing subsequent images of the subsequent field of view;
outputting the subsequent mask pattern with the initial parameters corresponding to one or more regions of interest in the second field of view; and
controlling an illuminating assembly of the microscope-based system to illuminate the one or more regions of interest of the subsequent field of view of the sample with the mask pattern.

21. The method of claim 20, wherein the trained artificial intelligence model is trained by the following steps comprises:
obtaining a training image of a sample captured by a microscope system, wherein the training image has a target pattern corresponding to regions of interest,
inputting the training image to an input layer of an artificial intelligence model architecture having a number of layers between the input layer and an output layer;
outputting a proposed pattern corresponding to the regions of interest with the output layer of the artificial intelligence model architecture;
comparing the proposed pattern against the target pattern to calculate a loss between the proposed pattern and the target pattern;
updating weights in the layers of the artificial intelligence model architecture based on the calculated loss; and
repeating the inputting, outputting, comparing, and updating steps until the calculated loss is below a loss threshold.

22. (canceled)

23. The method of claim 20, wherein the trained artificial intelligence model has been trained using validated examples of regions of interest from the training images.

24. The method of claim 20, wherein the trained artificial intelligence model is configured to segment one or more regions of interest from pixel value data of the first images.

25. The method of claim 20, wherein the the initial parameters may be changed or adjusted to achieve the desired output.

26. (canceled)

27. The method of claim 20, wherein images the first image and the subsequent images are captured by the microscope-based system with a different field of view.

28. The method of claim 20, wherein before capturing the first image of the first field of view, the method further comprises a step of introducing one or more photoactivatable probes to the sample, wherein the one or more photoactivatable probes is configured to bind to one or more regions of interest of the sample, and wherein the one or more probes are reactive to light by the illuminating assembly.

29. The method of claim 19, wherein the mask pattern is based on one or more regions of interest that photoactivatable probes bind the sample after illuminating by the illuminating assembly.

30. The method of claim 13, wherein the trained artificial intelligence model has been trained using validated examples of regions of interest from the training images.

31. The method of claim 12, wherein the first image and the subsequent images obtained from the microscope-based system are captured with a different field of view.

32. The method of claim 20, before inputting the first image into the trained artificial intelligence model, further comprising a step of standardizing image pixel values of the first image.

33. The method of claim 20, the mask pattern is based on one or more regions of interest that photoactivatable probes bind the sample after illuminating by the illuminating assembly.
